(19) United States
(12) Patent Application Publication
(10) Pub. No.: US 2023/0297044 A1
(43) Pub. Date: Sep. 21, 2023

(54) REAL-TIME CONTROL OF MECHANICAL VALVES USING COMPUTER VISION AND MACHINE LEARNING

(71) Applicants: KING ABDULLAH UNIVERSITY OF SCIENCE AND TECHNOLOGY, Thuwal (SA); KING FAHD UNIVERSITY OF PETROLEUM AND MINERALS, Dhahran (SA)

(72) Inventors: Tareq Yousef AL-NAFFOURI, Thuwal (SA); Mudassir MASOOD, Dhahran (SA); Abdulwahab Ayman FELEMBAN, Jeddah (SA); Mamdouh Fawaz ALJOUD, Medina (SA); Ahmed BADER, Tla'a Al-Ali District (JO); Mohammad Tamim ALKHODARY, Montreal (CA); Tarig Ballal Khidir AHMED, Thuwal (SA)

(21) Appl. No.: 18/021,241

(22) PCT Filed: Aug. 18, 2021
(86) PCT No.: PCT/IB2021/057589

§ 371 Date: Feb. 14, 2023

Related U.S. Application Data
(60) Provisional application No. 63/067,625, filed on Aug. 19, 2020.

(51) Int. Cl. G05B 15/02; G06V 40/16; G06V 40/10

(52) U.S. Cl. CPC G05B 15/02; G06V 40/174; G06V 40/107

(57) ABSTRACT

A smart-valve system for controlling a fluid includes a hybrid valve configured to control a flow of the fluid, wherein the hybrid valve includes electronics for controlling the flow of the fluid, and the hybrid valve also includes a manual handle for controlling the flow of the fluid, a controller connected to the electronics and configured to control the electronics to close or open the hybrid valve, a camera oriented to capture visual data about a user, and an artificial intelligence, AI, algorithm configured to receive the visual data from the camera, extract a user action or gesture from the visual data, generate a command associated with the user action or gesture, and send the command to the hybrid valve to control the flow of the fluid.

### CROSS-REFERENCE TO RELATED APPLICATIONS

This application claims priority to U.S. Provisional Patent Application No. 63/067,625, filed on Aug. 19, 2020, entitled “REAL-TIME CONTROL OF MECHANICAL VALVES USING COMPUTER VISION AND MACHINE LEARNING,” the disclosure of which is incorporated herein by reference in its entirety.

### BACKGROUND

### Technical Field

Embodiments of the subject matter disclosed herein generally relate to a system and method for controlling a mechanical valve based on computer vision and machine learning, and more particularly, to a mechanical valve that is controlled by a human operator without touching the mechanical valve.

### Discussion of the Background

Control valves (e.g., mechanical valves) form an important building block of industrial control systems. These valves are used to control the flow of liquids and gases between different parts of an industrial plant. An example of such plant might be a petrochemical plant that purifies crude oil. In such a plant, the crude oil flows into different stages while being purified and the flow must be controlled for a productive and safe operation of the whole plant. Historically, the flow of liquids and gases used to be controlled by manually controlled mechanical valves. As the valves are often installed at hard-to-reach locations, and they are exposed to harsh environments of the plants (e.g., high temperature locations), controlling them is a tedious task.

As the digital era started, digitally controllable valves were designed that were not only convenient to use, but also helped revolutionize the design of industrial plants. However, to test and calibrate some of these valves, it is often desirable that the valves are still manually controlled. In this case, the valves are actuated by a control wheel until desired flow rates are achieved. As highlighted above, these valves must be physically reached in order for being controlled, which requires proper planning taking into consideration the safety risks involved. Therefore, it is desired that these valves can still be controlled manually without reaching them physically.

A different problem exists for the water taps that people are using several times a day, but this problem may be solved with a novel system that also solves the valve problems in the industrial environment discussed above. The water taps are also controlled by mechanical control valves. In a particular household, the control of the mechanical taps is linked with efficient usage of water as well as the overall user experience. As water is the most valuable resource on earth, redefining how the taps are used could have a significant impact on preserving this precious resource. In fact, water consumption is an increasing worldwide concern, especially in countries with limited water resources. The Middle East and North Africa regions have 6% of the world's population and less than 2% of the world's renewable water resources. It is the driest region in the world, with the 12 most water-scarce countries in the world: Algeria, Bahrain, Kuwait, Jordan, Libya, Oman, the Palestinian Territories, Qatar, Saudi Arabia, Tunisia, the UAE and Yemen. For example, the Saudi Ministry of Water and Electricity indicated that individual water consumption in Saudi Arabia is 246 liters per day, which is three times the recommended individual rate that was defined by the World Health Organization as being 83 liters per individual per day. This rate has made Saudi Arabia one of the highest water consumers in the world. Several studies have shown that more than 40% of the water is being wasted during human-tap interaction for daily activities such as washing hands, face, brushing teeth, etc.

As the humans interact with these taps regularly, there is an imperative need to make them more efficient, to reduce the water waste. Thus, there is a need of a novel intelligent mechanical valve that addresses these problems.

### BRIEF SUMMARY OF THE INVENTION

According to an embodiment, there is a smart-valve system for controlling a fluid. The smart-valve system includes a hybrid valve configured to control a flow of the fluid, wherein the hybrid valve includes electronics for controlling the flow of the fluid, and the hybrid valve also includes a manual handle for controlling the flow of the fluid, a controller connected to the electronics and configured to control the electronics to close or open the hybrid valve, a camera oriented to capture visual data about a user, and an artificial intelligence, AI, algorithm configured to receive the visual data from the camera, extract a user action or gesture from the visual data, generate a command associated with the user action or gesture, and send the command to the hybrid valve to control the flow of the fluid.

According to another embodiment, there is a method for controlling a hybrid valve, and the method includes collecting visual data associated with a user and a hybrid valve, transmitting the visual data from a camera to a controller, that is hosting an artificial intelligence, AI, algorithm, processing the visual data with the AI algorithm to extract a user action or gesture, generating a command with the AI algorithm based on the extracted user action or gesture, and sending the command to the hybrid valve to control a parameter of a fluid flowing through the hybrid valve.

### BRIEF DESCRIPTION OF THE DRAWINGS

For a more complete understanding of the present invention, reference is now made to the following descriptions taken in conjunction with the accompanying drawings, in which:

FIG. 1 shows a smart-valve system that has a hybrid valve, a camera, a controller, and an artificial intelligence, AI, algorithm that controls the hybrid valve based on input from the camera;

FIG. 2 shows another smart-valve system that includes plural hybrid valves controlled by the AI algorithm;

FIG. 3 shows the smart-valve system distributed at various locations in a plant;

FIG. 4 shows the smart-valve system having a temperature sensor so that the AI algorithm is capable of adjusting a temperature of the controlled fluid;

FIGS. 5A and 5B illustrate various fluid flow shapes that are implemented by the AI algorithm at the hybrid valve;

FIGS. 6A and 6B schematically illustrate the configuration of a neural network used by the AI algorithm;

FIG. 7 shows the smart-valve system having a spout with a movable part that is controlled by the AI algorithm to adjust a direction of the flow based on a characteristic of the user;

FIG. 8 shows the smart-valve system having in addition to the camera, a microphone and a speaker such that the AI algorithm verbally interacts with the user;

FIG. 9 shows the smart-valve system having the controller, that hosts the AI algorithm, integrated with the hybrid valve or the camera;

FIG. 10 shows the smart-valve system having a germ detection sensor for detecting germs on the user's hands; and

FIG. 11 is a flow chart of a method for using the smart-valve system to control the hybrid valve based on visual data of the user.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a mechanical valve that controls the flow of a fluid in an industrial or household environment. However, the embodiments to be discussed next are not limited to a mechanical valve, or an industrial or household environment, but may be applied to other valves or in other environments.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, there is a novel system that is configured to control at least one of the flow rate, pressure, flux, temperature, flow duration and direction of the fluid flowing through a mechanical valve, by analyzing human actions and/or gestures associated with the user of the mechanical valve. In one application, it is possible to use a machine learning/deep learning based computer model to identify in real-time the human actions and/or gestures for the purpose of controlling the mechanical valve. In this or another application, it is also possible to use a machine learning/deep learning-based computer model that is capable of predicting future actions/gestures of humans interacting with the mechanical valve to increase the overall system efficiency. In yet another application, it is possible to have a hygiene compliance system for healthcare industry that also uses a machine learning/deep learning-based computer model to predict a reaction time of the human using the hygiene system and thus, to turn on and off the mechanical valve based on the predicted reaction time. These various applications are now discussed in more detail with regard to the figures.

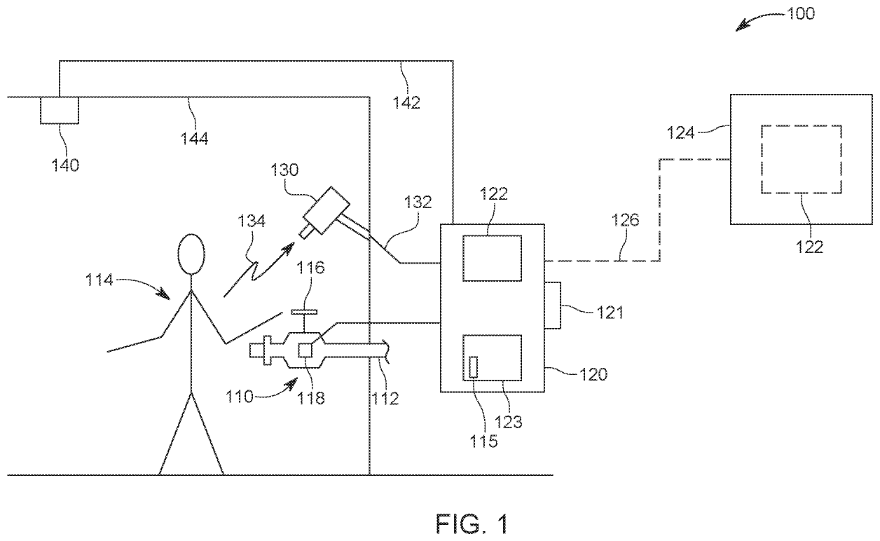

According to an embodiment, as illustrated in FIG. 1, a smart-valve system 100 includes a hybrid valve 110, which is configured to control the flow of a fluid through a pipe 112. The hybrid valve 110 is configured to be mechanically opened by a person 114, with the help of a handle 116. However, the hybrid valve 110 also includes electronics 118, for example, a solenoid, that can be digitally activated by a controller 120 to open or close the valve. The controller 120 is shown in the figure being placed next to the hybrid valve 110. However, in one embodiment, the controller 120 may be placed away from the hybrid valve 110, for example, in a control room of a plant, or directly on the hybrid valve. No matter where the controller 120 is located, the controller may be wired directly to the electronics of the hybrid valve, or it may communicate in a wireless manner with the electronics of the hybrid valve. In one application, the controller 120 communicates over an Internet link with the hybrid valve, which means that the electronics 118 of the hybrid valve may include an Internet interface, or a wireless receiver, satellite receiver, etc. The controller may be implemented as a computer, processor, microprocessor, FPGA, an application specific integrated circuit, etc.

The controller 120 may be configured as a neural network that runs an artificial intelligence (AI) algorithm 122 for processing data. Alternatively, the AI algorithm 122 may be stored at a remote, central, server 124, that is linked by a wired or wireless communication link 126 to the controller 120. The AI algorithm 122 is configured and trained to receive visual data 132, from a camera 130 or equivalent sensor. The camera 130 may operate in the visible, infrared, ultraviolet, or any other spectrum as long as the camera is able to detect a movement of the user 114. The camera 130 is located in such a way that a gesture or equivalent indicia made by the user 114, with regard to the hybrid valve 110, can be recorded and transmitted to the AI algorithm 122. In one application, the camera 130 is oriented to capture both the user and the hybrid valve.

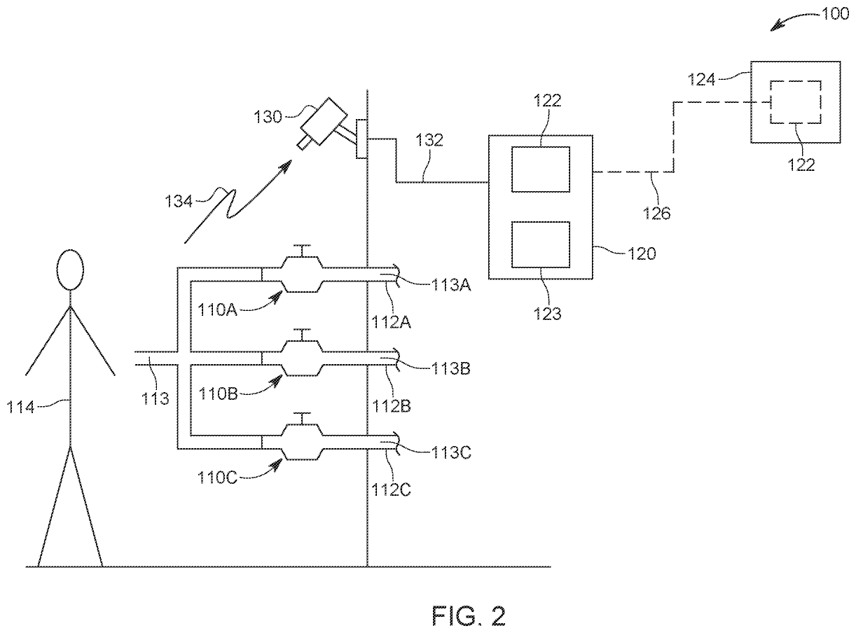

The AI algorithm 122 processes visual data 134 recorded by the camera 130 and determines an action to be taken by the hybrid valve 110, for example, to increase or decrease a rate or flux of the fluid through the pipe 112, to control a flow duration of the fluid through the pipe, to regulate a flow direction of the fluid, and/or to adjust a temperature of the fluid. For one or more of these actions, it is possible that plural pipes 112A to 112C and corresponding plural hybrid valves 110A to 110C are used to combine various fluid streams 113A to 113C into a single fluid stream 113, as illustrated in FIG. 2. As the various fluid streams 113A to 113C may have various flow rates, and/or temperature, and/or directions, it is possible to adjust the final flow rate, or temperature, or flowing direction of the fluid stream 113 by independently controlling the hybrid valves 110A to 110C.

To be able to adjust one or more of these parameters of the final stream 113, the AI algorithm 122 needs to receive visual data 134 that includes at least one of grayscale or RGB or video images of the user 114, or depth information regarding the user, or human gestures, or non-human visual signals. In one application, there are additional sensors 140 located around the user 114, as shown in FIG. 1, for collecting additional data 142 to be supplied to the AI algorithm 122. For example, FIG. 1 shows a temperature sensor 140 that is located in the same room/enclosure 144 as the user 114. The sensor 140 may also include, in addition or instead of the temperature sensor, a pressure sensor, a light sensor, weather conditions, etc. If the temperature sensor is used, the temperature data may be used by the AI algorithm 122 to mix the various streams 113A to 113C (see FIG. 2) to provide the user 114 with a stream 113 that has a temperature adjusted to the environment of the room 144. For example, if the user is using the stream 113 to wash its hands, and the temperature in the room 114 is very high, the AI algorithm 122 may lower the temperature of the stream 113 to make it more refreshing to the user. A profile 115 of the user 114 may also be stored in the controller 120 and/or the AI algorithm 122 or a storage device 123, located in the controller 120 or in the server 124. In this way, the AI algorithm 122 compares the user's profile 115 with the temperature data 144 and determines the appropriate temperature for the stream 113.

The user profile 115 may include, but is not limited to, a photo of the user, a photo of the face of the user so that the AI algorithm can automatically determine which user is using the system, the age, height, weight, sex, and/or any preference of the user (e.g., the user prefers water at 25 C for washing his/her hands, water at 31 C for washing his/her face, etc.). In one embodiment, if the system 100 is used in an industrial environment, a user may be associated with oil analysis, another user may be associated with gas testing, etc. In other words, any user may be associated with any desired characteristic or feature related to the system to be used. The user profile may be modified by the user or another user through a computing device that is connected to the controller 120, or by using an input/output interface 121 associated with the controller 120, as shown in FIG. 1.

The visual data 134 may include, as discussed above, human gestures, human actions, visual clues, and any other visual indication that might not be related to humans. A human gesture may include different pre-defined human gestures, for example, raising a hand, stretching an arm, bending the arm, bending the body at a certain angle, smiling, covering his or her face, etc. Different mechanical valve operations can be conducted by performing actions such as raising the right hand, stretching both arms, etc. In other words, each possible action of the hybrid valve can be associated with a unique gesture of the user, and all this information may be stored in the user's profile 115. A human action may include, but is not limited to, hand washing, face washing, moving hands in a circular fashion, bowing, etc. A visual clue may include an image that records at least one parameter, i.e., the amount of light in a given place, the presence or absence of one or more persons in a given place, a particular behavior of one or more persons, etc.

In this way, the AI algorithm receives an input from the camera 130 and/or sensors 140, an input from the storage device 123, which stores the profiles 115 of the users 114, and also may receive an input from a remote server 124. Based on this information, the AI algorithm 122 is trained to provide a certain instruction to the controller 120, to control the hybrid valve 110.

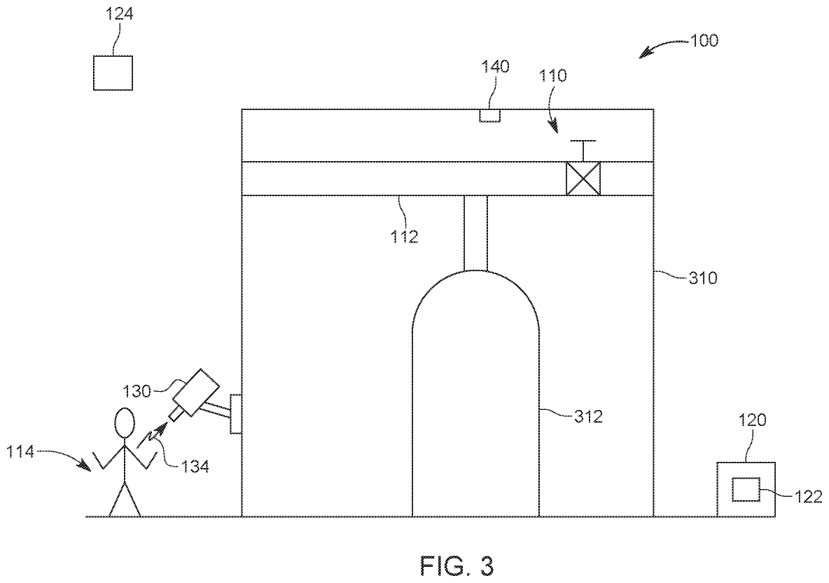

While FIGS. 1 and 2 show the user 114 being located next to the hybrid valve 110, in one application, as shown in FIG. 3, it is possible to have the system 100 distributed at various locations in the plant. More specifically, FIG. 3 shows a plant 310 that hosts a reactor 312, to which the pipe 112 is connected. The hybrid valve 110 is located above the reactor, in a place hard to be accessed by the user 114. The user 114 and the camera 130 may be located outside the plant 310, while the controller 120, also located outside the plant 310, may be located away from the camera and the user. The server 124 may be located remotely from all these locations. However, all these elements are still connected (in terms of communication) to each other and the AI algorithm stored by the controller or the server associates the user 114 with his/her profile 115, identifies the hybrid valve 110 that the user has access to, based on the profile 115, and allows the user to control the hybrid valve 110, remotely, based on the visual data 134 collected by the camera 130. In one application, multiple hybrid valves 110 are associated with a single user 114. In this case, the profile 115 of the user has an entry for each hybrid valve, and a unique human gesture or action of the user 114 is associated with the activation of each hybrid valve. In this way, the user initially makes a first gesture or action to the camera to login into his/her profile, then makes a second gesture or action to select the correct hybrid valve, and finally makes a third gesture or action to select a specific control action for that hybrid valve. For example, the first gesture may be the user's face, the second gesture may be a show of a number of fingers for identifying the correct valve, and the third gesture or action may be raising a hand, to open the valve. Other gestures or actions or combinations of them may be used to achieve additional functionalities for the selected valve.

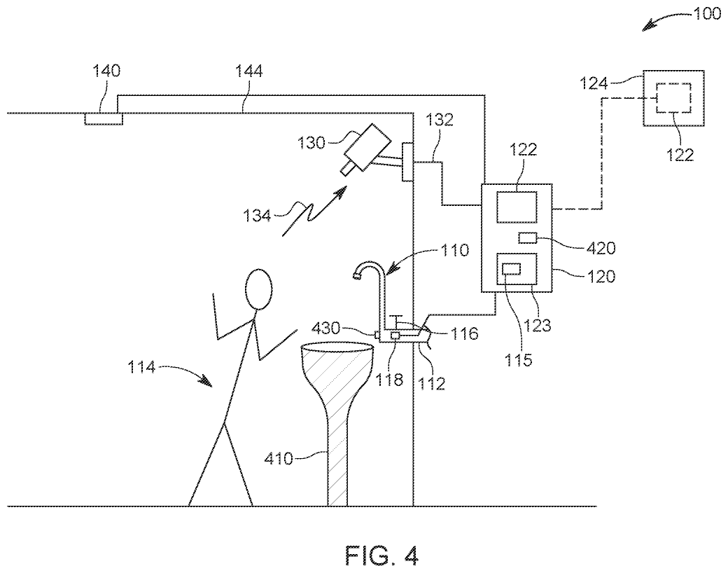

While the embodiments discussed above have been discussed mainly with regard to an industrial environment, the next embodiment is adapted for use in a public or household washing area, e.g., the rest room in an office or the bathroom in a personal home, when the privacy of the user is not of concern or it is kept confidential. The system 100 may be used in this embodiment, with some additional features as now discussed with regard to FIG. 4. FIG. 4 shows a bathroom 144 having a hybrid water tap 110 that is configured to provide water. A sink 410 is associated with the hybrid water tap 110 and is configured to collect the water from the water tap. A camera 130 is installed on a wall of the bathroom and oriented to capture visual data 134 associated with the user 114. The electronics 118 of the hybrid water tap 110 is electrically connected to the controller 120. The AI algorithm 122 and the profile 115 of the user 114 are accommodated by the controller 120. A server 124 may host the AI algorithm 122, or may be in communication with the controller 120 for supplying additional information.

The user 114 interacts with the hybrid water tap 110 to perform daily operations, like hand washing, face washing, brushing teeth, shaving, etc. The controller 120 is configured to switch on and off the hybrid water tap 110 by interacting with its electronics 118, based on live commands generated by the AI algorithm 122. The AI algorithm 122 is configured and trained to analyze the hand movements (or head movements or body movements) of the user, based on the visual data 134, and to turn the water tap on or off. The AI algorithm 122 may also be configured to recognize the action undertaken by the person using the hybrid water tap and adjust the pressure of the water stream according to the requirements of the action. For example, collecting water to wash the face needs more water as compared to soaking a teeth brush, and thus, the water pressure should be different for these two scenarios. The AI algorithm is trained to recognize and distinguish these two actions and provide the appropriate water pressure associated with each action. For this embodiment, a list 420 may be stored by the controller 120 and the list maps each action recognized by the AI algorithm to a corresponding water pressure or temperature or flow, etc.

In another embodiment, which may be combined with the above embodiment, the AI algorithm is configured and trained to recognize the action of the person using the tap and adjust the amount of water dispensed according to the requirements of the action. For example, if a person wants to wash his/her face, the amount of water dispensed should not exceed that requirement, which is previously calculated and stored in the list 420. Similarly, if a person intends to soak his/her teeth brush, only a little amount of water should be dispensed and so on. All these amounts are previously researched and calculated and stored in the list 420. In one application, depending on the age or height or mass of the user, the AI algorithm may further adjust up or down these amounts according to one or more of these characteristics.

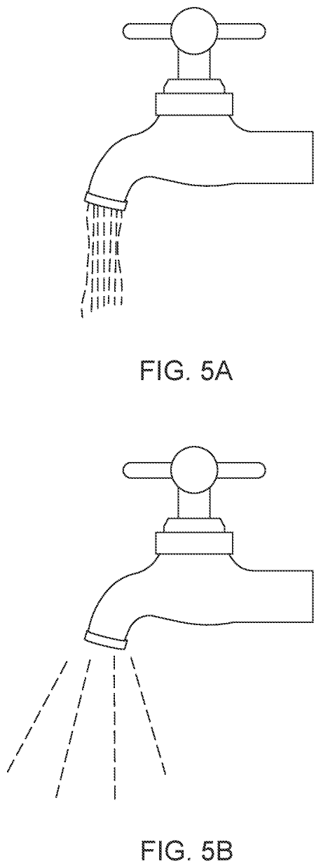

Further, the AI algorithm 122 may be trained to recognize the action undertaken by the person using the hybrid water tap and adjust the shape of the water flow accordingly. For example, collecting water in the hands can be done conveniently if the water flow is solid, as shown in FIG. 5A. However, such a shape of water will make a splash if a person intends to wash his arms. Therefore, starting with a sprinkle, as shown in FIG. 5B, followed by a solid shape, as shown in FIG. 5A, might be more effective in the latter scenario. Those skilled in the art would understand that any number of different water flows may be obtained with the hybrid water tap 110.

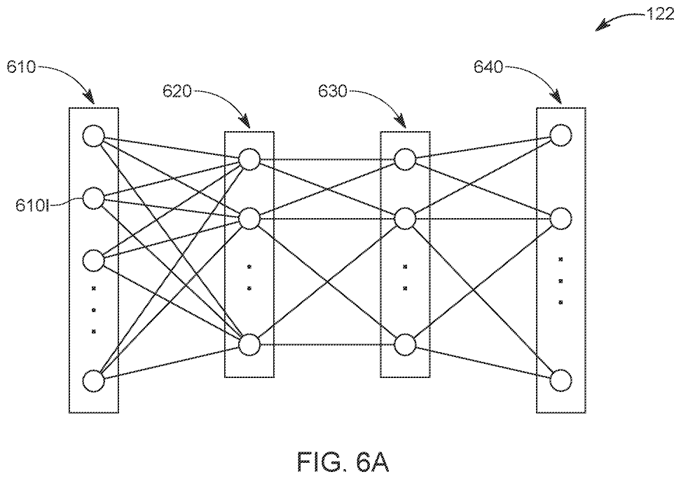

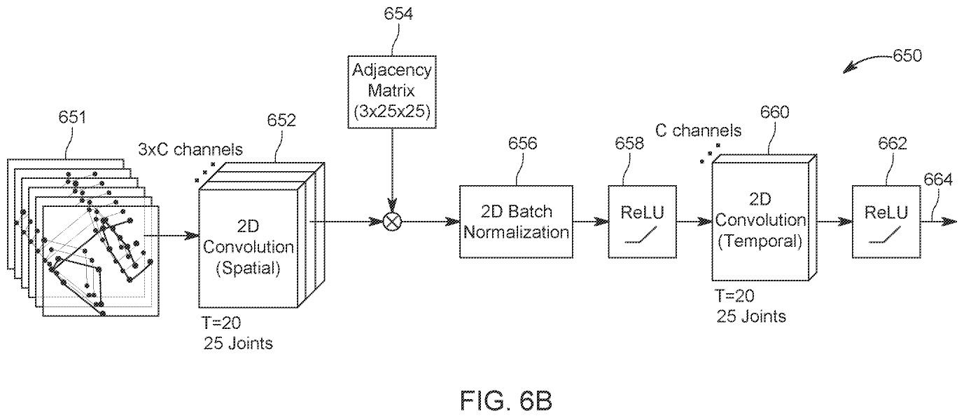

The AI algorithm 120, which is schematically illustrated in FIG. 6A, includes an input layer 610, plural hidden layers 620 and 630 (only two are shown for simplicity, but more layers may be used), and an output layer 640. The input layer 610 includes plural nodes 6101, where I is an integer between 1 and N, where N is the maximum number of actions and/or gestures that are desired to be distinguished from the visual data 134. In other words, if it is desired to distinguish only between one hand up and both hands up, then N=2. However, in an actual situation, it is possible that N is 10 or 20. With regard to FIG. 2, if a large number of valves are desired to be controlled by one single user, N needs to be larger than the number of valves. The nodes from the input layer 610 are connected to the hidden layers. The hidden layers may be convolution layers, deconvolution layers, recursive layers, etc. In some cases, weighted inputs are randomly assigned to the hidden layers. In other cases, they are fine-tuned and calibrated through a process called backpropagation. Either way, the artificial neuron in the hidden layer works like a biological neuron in the brain, i.e., it takes in its probabilistic input signals, works on them and converts them into an output corresponding to the biological neuron's axon. More than two hidden layers may be used. The output layer 640 has as many nodes as many actions are desired to be implemented to the hybrid tap water. For example, if the flow, temperature, and shape of the water stream are desired to be controlled, then the output layer has at least three nodes. More or less nodes may be used depending on the desired number of states that need to be applied to the water tap.

A specific implementation of the AI algorithm 122 is now discussed with regard to FIG. 6B. In this embodiment, human skeleton information may be acquired through a specialized depth camera (e.g., Microsoft Kinect, or Intel Realsense) to train the AI algorithm 122. The captured skeleton video data is in the form of three-dimensional (3D) graphs. Thus, the Spatial-Temporal Graph Convolutional Network (ST-GCN) architecture (see Sijie et al., Spatial Temporal Graph Convolutional Networks for Skeleton-Based Action Recognition, arXiv:1801.07455v2, 2018) is used for the AI algorithm 122. The 3D human skeleton data is the input to this network. Compared to the original ST-GCN, two changes are implemented in the configuration of FIG. 6B to make it anticipate actions in real-time. First, short sequences of 20 3D skeleton video frames are used for training as well as processing the data. This is unlike feeding all the frames to the network usually used by other methods. The 20 frames sequences are captured and processed in real-time during every iteration where one new frame replaces the oldest frame in every iteration. The second difference is that each sequence is labeled with the class label of an upcoming action instead of the action occurring during the 20 frames sequence. This change is relevant for predicting the action of the user, which is a feature that is discussed later. This change is made to offset the delays due to model inference time, the mechanical valve actuation, and the signal propagation in electronic circuits. FIG. 6B illustrates a single block 650 of the used ST-GCN model while the ST-GCN model consists of multiple blocks to extract high-level features of the input graph. The ST-GCN model in FIG. 6B receives the input data 651 (visual data 134) at a 2D spatial convolution layer 652. The output of the convolution layer 652 is combined with the output from an adjacency matrix 654, which indicates which vertex is connected to another vertex, and then fed to a 2D batch normalization layer 656 for normalizing a mini-batch of data across all observations for each channel independently. The output from this layer is fed to a ReLU layer 658 to perform a threshold operation, and then to a temporal 2D convolution layer 660 for convolution. Finally, another ReLU layer 662 performs another threshold operation to each element of the input and outputs a predicted time 664, which is discussed later.

The AI algorithm may also be configured and trained to dispense water at a temperature that is comfortable for the person. In order to achieve this functionality, the system 100 in FIG. 4 may have, in addition to the ambient temperature sensor 140, a water temperature sensor 430, which may be attached to the water tap 110 or the pipe 112. Thus, both the room and the water temperature are measured and provided to the controller 120 to prepare a proper mix of the cold and hot water incoming at the water tap. In addition to that, the hybrid water tap may access the current weather conditions, from the server 124, to make a more informed decision about the temperature of the water to be dispensed. In this regard, it is known that a user needs hotter water in winter than in summer for the same action. The AI algorithm thus recognizes not only the different human actions, but also calculates the proper water temperature based on the ambient and meteo conditions.

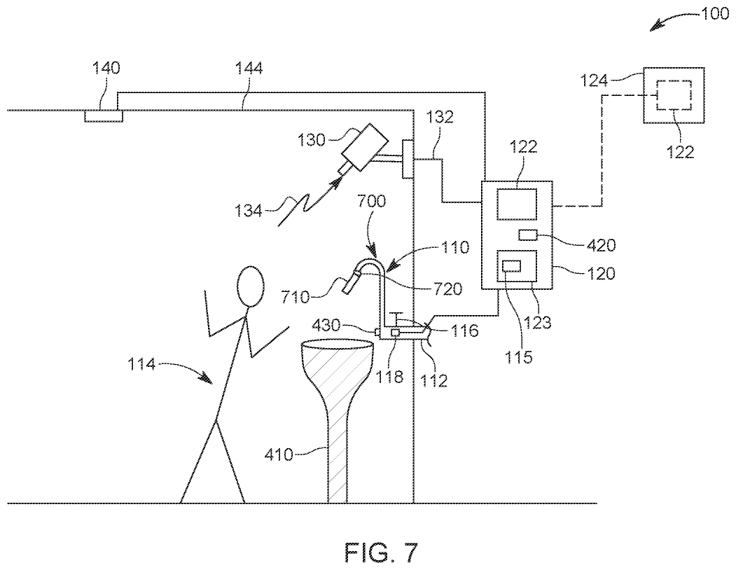

In another embodiment, which may be combined with any of the above discussed embodiments, the spout of the hybrid water tap 110 may be controlled by the controller 120 to change its orientation, and thus, to direct the water stream in a different direction. For this embodiment, which is shown in FIG. 7, the spout 700 has a movable part 710, which may be actuated with a motor 720. The motor may be controlled by the controller 120. For example, if the user is an old age user, special needs, and/or physically challenged person, it is sometimes difficult to move his/her hands at the bottom of the spout to perform the desired washing task. For such users, the AI algorithm 122 recognizes, based on the store profile 115, that the end spout 710 needs to be actuated to change the direction of the water flow towards the user. In this way, the user will not have to struggle to reach at the bottom of the spout.

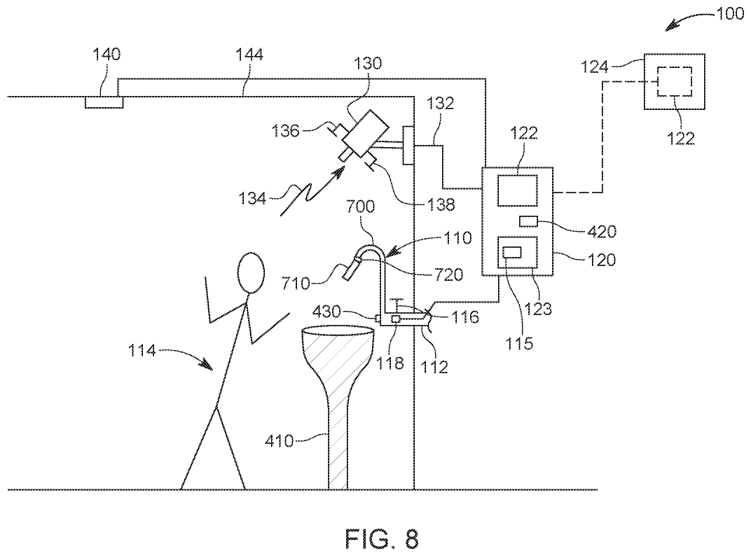

While all the embodiments discussed above use the camera 130 to either identify the user and use its profile 115 and/or to identify the user's gesture or action to control the hybrid valve 110, in one embodiment, as illustrated in FIG. 8, the camera 130 may have a microphone 136 and a speaker 138 to allow verbal interaction between the user 114 and the AI algorithm 122. Thus, in this embodiment, a combination of visual data recognition and verbal interaction with the user may be implemented by the AI algorithm 122 to achieve any of the functionalities discussed above.

The profiles 115 of the users may be especially applicable for the taps in a household. The hybrid water taps can learn the personal preferences and styles of washing for each person in a household and save it to the personal profile. These profiles can be continuously updated to continue to adapt to the changing styles of the users. These profiles can be stored in the local database 123 or on the cloud, in the server 124.

In yet another embodiment, which may be combined with any of the above discussed embodiments, the hybrid water tap may be configured to switch off when the hands of the user move away from the water tap. This action is implemented by the AI algorithm 122 based on an estimated distance between the hands and the hybrid water tap, as recorded by the camera 130. However, as the hybrid water tap includes a mechanical moving part (solenoid valve), which needs some time to be actuated/stopped, there is a delay between the moment when the hybrid water tap's stopping signal is generated by the controller 120 and the moment when the water actually stops flowing from the hybrid water tap 110. Although at each instance of stopping the hybrid water tap the amount of water wasted is small, the total amount of water wasted when combined for a large number of users in a city could be very large, when considering the daily water usage of the city. To address this issue, in this embodiment, the smart-tap system 100 is provided with a prediction mechanism (e.g., the configuration shown in FIG. 6B). Specifically, the AI algorithm 122 may be adapted or another algorithm may be used to predict the next action of the user. For example, if a user is collecting water in his/her hands to wash his/her face, the hybrid water tap together with the controller 120 should predict when the user will start moving his/her hand away from the water tap and based on this prediction, stop the water flow until his/her hands are approaching again the spout of the water tap. The prediction would allow the system to send an early stopping signal to offset the delay incurred by the solenoid valve in the water tap. As the delay varies from one hybrid water tap to another, and from one user to another, the modified AI algorithm 122 learns this parameter for each tap and for each user. Moreover, with time, the behavior of the solenoid valve may change. Therefore, the above-mentioned capability of the AI algorithm associated with the water tap continuously adapts, which is beneficial.

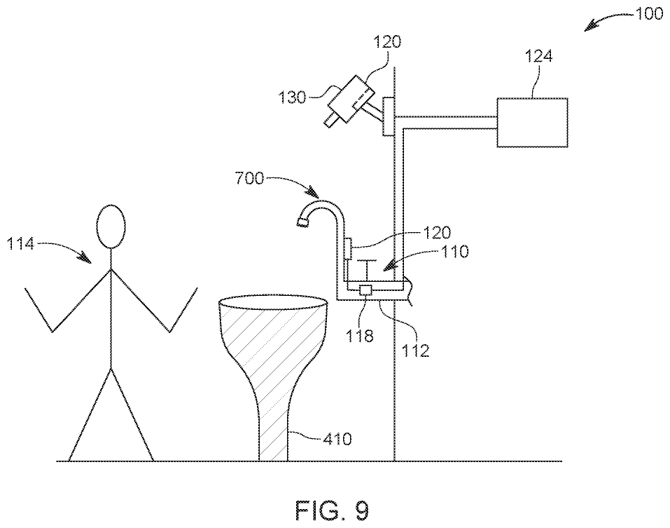

While the embodiments discussed above show the controller 120 being located behind a wall, opposite to the hybrid water tap 110, in one embodiment, as illustrated in FIG. 9, the controller 120 is integrated with the hybrid water tap 110. Alternatively, as shown by a dash line still in FIG. 9, the controller 120 may be integrated with the camera 130. Note that most of the features previously described are not shown in FIG. 9 for simplicity. However, any of those features may be combined with the configuration shown in this figure.

Another aspect of the prediction characteristic of the AI algorithm 122 is related to the desired to offer a smooth user experience. Consider the example of a person washing his/her face as discussed above. When the person, after washing his/her face, moves his/her hands again towards the hybrid water tap, the hybrid water tap may predict the exact moment when the user will expect the hybrid water tap to dispense the water. This prediction (i.e., time at which the water should start flowing) may then be used to switch on the hybrid water tap at the right moment, i.e., when the hands of the user just reach under the spout, thus enhancing the overall user experience. The AI algorithm 122 would be trained to learn, recognize and predict the future movements of the person using the hybrid water tap, as discussed above with regard to FIG. 6B.

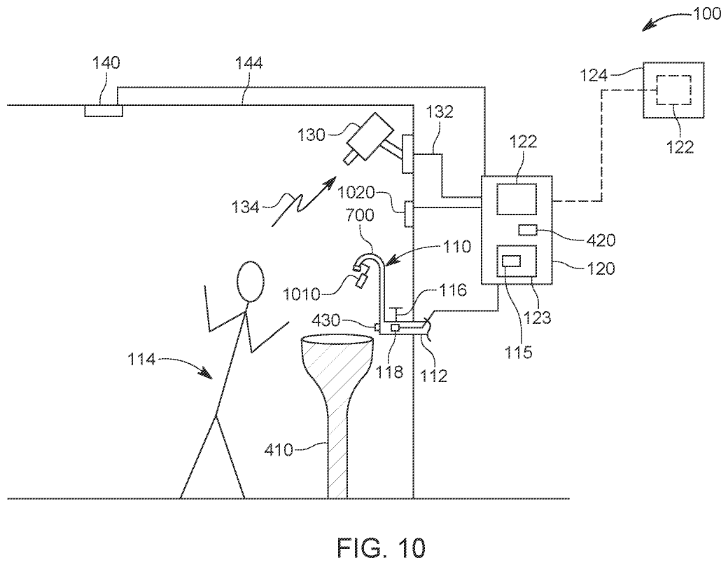

In yet another embodiment, which is illustrated in FIG. 10, additional sensors and computer vision capabilities are added to the system 100 for monitoring the hygiene of the person using the hybrid water tap 110. The system shown in FIG. 10 may be combined with any feature or features previously discussed. More specifically, the system 100 in FIG. 10 has at least one additional sensor 1010, called herein germ detection sensor, which is either attached to the spout 700 or other part of the hybrid water valve 110, or to the wall 144 of the enclosure where the hybrid water valve 110 is located. The germ detection sensor 1010 is in communication with the electronics 118 or controller 120, either in wired or wireless manner. The germ detection sensor 1010 is configured to detect a germ on the user's hands. For example, the germ detection sensor may use electrochemical electrodes, or may use fluorescence, magnetic field, etc. for detecting the germs. Germ detection sensors may be found, for example, at us.moleculight.com, or pathspot.com.

In this way, the modified system 100 is capable to determine in real time if a certain germ is still present on the user's hands, even after the user has finished using the hybrid water tap. For this situation, the AI algorithm 122 is configured to generate an alarm and sound a sound at a speaker 1020 or generate a warning light with a light source 1020 so that the user is made aware that he or she needs to continue to wash the hands. This modified smart-tap-hygiene system would be very useful in the healthcare or food handling industries as the workers here need to have their hands clean before touching the patients or the food. These are also environments where the privacy of the users has a lower threshold, i.e., it is expected that their hands are monitored by such systems for ensuring clean hands.

While some of the above embodiments were discussed with regard to a hybrid water tap provided next to a sink, it is possible to use the novel features disclosed herein with a hybrid water tap with no sink, for example, when used with a public shower or an industrial shower or any other situation where the privacy of the user is not of concern.

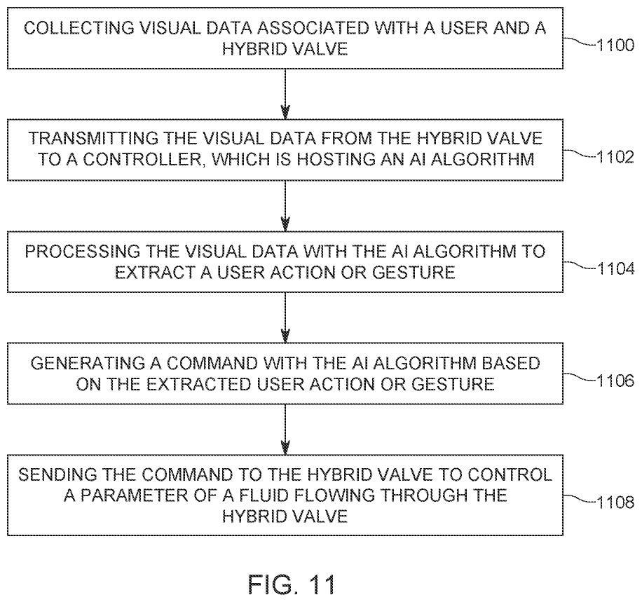

According to the embodiment illustrated in FIG. 11, a method for controlling a hybrid valve includes a step 1100 of collecting visual data 134 associated with a user 114 and a hybrid valve 110, a step 1102 of transmitting the visual data from the hybrid valve to a controller 120, which is hosting an AI algorithm 122, a step 1104 of processing the visual data with the AI algorithm to extract a user action or gesture, a step 1106 of generating a command with the AI algorithm based on the extracted user action or gesture, and a step 1108 of sending the command to the hybrid valve to control a parameter of a fluid flowing through the hybrid valve. In one application, the command controls at least one of a temperature of the fluid, a pressure of the fluid, a time to turn on the hybrid valve. The parameter may be a temperature or a flow rate, or flow shape, or on or off state of the hybrid valve.

The method may further include a step of storing in the controller profiles associated with various users of the hybrid valve, and a step of generating the command based on a given profile of the profiles, which is associated with a given user that is currently using the hybrid valve. The method may also include a s step of receiving germ information at the AI algorithm, and a step of generating a warning for the user when germs are detected on the user's hands. The method may also include a step of delaying a turning on state of the hybrid valve based on a profile of the user stored in the controller. In one application, the AI algorithm is configured to learn from each user to predict a next movement or a time until the movement takes place.

The disclosed embodiments provide a smart-valve system that is capable of being operated by visual data associated with a user without the user practically touching the valve. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A smart-valve system for controlling a fluid, the smart-valve system comprising:
a hybrid valve configured to control a flow of the fluid, wherein the hybrid valve includes electronics for controlling the flow of the fluid, and the hybrid valve also includes a manual handle for controlling the flow of the fluid;
a controller connected to the electronics and configured to control the electronics to close or open the hybrid valve;
a camera oriented to capture visual data about a user; and
an artificial intelligence, AI, algorithm configured to receive the visual data from the camera, extract a user action or gesture from the visual data, generate a command associated with the user action or gesture, and send the command to the hybrid valve to control the flow of the fluid.

2. The smart-valve system of claim 1, wherein the user action or gesture is a hand orientation.

3. The smart-valve system of claim 1, wherein the user action or gesture is a facial expression.

4. The smart-valve system of claim 1, wherein the controller hosts the AI algorithm and also a database of profiles of users, and the AI algorithm is configured to match a facial expression of the user, captured with the camera, to a corresponding profile, and control the hybrid valve based on information stored in the profile.

5. The smart-valve system of claim 4, wherein the information is related to at least one of a temperature of the fluid, a pressure of the fluid, a time to turn on the hybrid valve, a direction of the fluid, a time to turn off the hybrid valve.

6. The smart-valve system of claim 1, further comprising:
a temperature sensor located next to the user and configured to supply a measured temperature to the AI algorithm to adjust a temperature of a dispensed fluid.

7. The smart-valve system of claim 1, wherein the hybrid valve is an industrial valve in a plant, remotely located from the user so that the user does not have physical access to the hybrid valve.

8. The smart-valve system of claim 1, further comprising:
additional hybrid valves controlled by the same controller,
wherein the AI algorithm is configured to individually control each hybrid valve to adjust a temperature of a dispensed fluid.

9. The smart-valve system of claim 1, wherein the camera is oriented to capture both the user and the hybrid valve.

10. The smart-valve system of claim 1, wherein the hybrid valve is a water tap, and the water tap has a movable part attached to a spout, and the AI algorithm is configured to orient the movable part toward the user when detecting a given indicator in a profile of the user stored in the controller, wherein the indicator is associated with an age or disability of the user.

11. The smart-valve system of claim 1, further comprising:
a microphone configured to collect a voice of the user and provide this data to the AI algorithm for controlling the hybrid valve; and
a speaker configured to provide verbal commands to the user.

12. The smart-valve system of claim 1, wherein the controller hosts the AI algorithm and the controller is integrated with the hybrid valve.

13. The smart-valve system of claim 1, further comprising:
a germ detection sensor configured to detect a presence of a germ on the user's hands and to provide such information to the AI algorithm,
wherein the AI algorithm is configured to warn the user about the presence of the germs.

14. A method for controlling a hybrid valve, the method comprising:
collecting visual data associated with a user and a hybrid valve;
transmitting the visual data from a camera to a controller, that is hosting an artificial intelligence, AI, algorithm;
processing the visual data with the AI algorithm to extract a user action or gesture;
generating a command with the AI algorithm based on the extracted user action or gesture; and
sending the command to the hybrid valve to control a parameter of a fluid flowing through the hybrid valve.

15. The method of claim 14, wherein the command controls at least one of a temperature of the fluid, a pressure of the fluid, a direction of the fluid flow, and a time to turn on or off the hybrid valve.

16. The method of claim 14, wherein the parameter is a temperature or a flow rate, or flow shape, or on or off state of the hybrid valve.

17. The method of claim 14, further comprising:
storing in the controller profiles associated with various users of the hybrid valve; and
generating the command based on a given profile of the profiles, which is associated with a given user that is currently using the hybrid valve.

18. The method of claim 14, further comprising:
receiving germ information at the AI algorithm, from a germ sensor that monitors the user; and
generating a warning for the user when germs are detected on the user's hands.

19. The method of claim 14, further comprising:
delaying a turning on state of the hybrid valve based on a profile of the user stored in the controller.

20. The method of claim 14, wherein the AI algorithm is configured to learn from each user to predict a next movement or a time until the movement takes place.
